(19) United States
(12) Patent Application Publication
(10) Pub. No.: US 2024/0371550 A1
(43) Pub. Date: Nov. 7, 2024

(54) IMPROVED NEGATIVE TEMPERATURE COEFFICIENT THERMISTOR

(71) Applicant: THE WARMING SURFACES COMPANY OY, Oulu (FI)

(72) Inventor: Terho Kololuoma, Oulu (FI)

(21) Appl. No.: 18/566,942

(22) PCT Filed: May 3, 2022
(86) PCT No.: PCT/FI2022/050288

§ 371 Date: Dec. 4, 2023

(30) Foreign Application Priority Data
Jun. 8, 2021 (FI) 20215666

(51) Int. Cl. H01C 7/04; G01K 7/22; H01C 17/065

(52) U.S. Cl. CPC H01C 7/043; G01K 7/223; H01C 17/06533; H01C 17/06586

(57) ABSTRACT

A negative temperature coefficient type thermistor that comprises at least two conductor terminals and a thermistor structure formed of particles of lithium manganese oxide in a spinel structure within a polymer binder. The thermistor is configured to operate in a temperature range below a predefined first temperature and the polymer binder is selected so that its heat distortion temperature is higher than the first temperature. The manufacturing process further includes a stage of calendaring the thermistor structure in a temperature that is higher than the heat distortion temperature of the polymer binder.

### FIELD OF THE DISCLOSURE

The application relates to thermistors, and more particularly to a negative temperature coefficient type thermistor, a method for manufacturing such thermistor, and a printed electrical device including such thermistor.

### BACKGROUND

In a printed electronic device, one or more defined patterns of electrically functional ink have been formed on a suitable substrate. Examples of printing methods applicable for forming such electrically functional patterns include inkjet printing, offset lithography, gravure- and flexography printing, and screen printing, to mention some. One possible electrically functional pattern is a resistor, a passive two-terminal electrical component that creates resistance in the flow of electric current. By adjusting resistor characteristics, this resistance may be made dependent on a physical quantity, like temperature, light level, voltage, magnetic field, mechanical load, etc. All resistors have some dependency on temperature, and for many applications the temperature coefficient of the resistor is typically minimised. However, there are also several applications where dependency on temperature is effectively utilised, and a specific resistor whose resistance is configured to be strongly dependent on temperature is called a thermistor. A Negative Temperature Coefficient (NTC) thermistor is a resistor that has a negative temperature coefficient, which means that its resistance decreases as the temperature of the thermistor structure increases. A Positive Temperature Coefficient (PTS) thermistor is a resistor that has a positive temperature coefficient, which means that its resistance increases as the temperature of the thermistor structure increases.

NTC thermistors are more common in applications, and they are typically used as resistive temperature sensors, heating elements and current-limiting devices. A conventional NTC thermistor exhibits a large, precise and predictable decrease as the temperature of the resistor increases and achieves high precision within a limited temperature range (typically of about 50° C.) around a target temperature. Conventional NTC thermistors are manufactured by mixing two or more semiconductor powders made of metallic oxides with a binder to form a slurry. The slurry is then formed over the lead wires and sintered at temperatures of the order of 850 degrees to form a dense ceramic oxide with a specific crystal structure. During this process the slurry makes an electrical connection with the wires. These conventional thermistor structures perform well and are widely used, but they are naturally not applicable for printed electronics. Furthermore, typical metal oxides used in NTC thermistors include heavy metals like cobalt, nickel, and iron combined with manganese and titanium. Heavy metals are, however, toxic and therefore their use is no longer considered to meet the increasing sustainability requirements. They are also considered too risky for many modern applications, such as wearable electronics where these toxic materials would be in contact with skin, or thermal management of food chains where these toxic materials would be in contact with food or drinks.

An approach suitable for printed electronics is to use an ink comprising particles in a binder. The overall transport of electrical current follows a percolation path between interconnecting particles and clusters of particles such that the nominal, or room temperature, resistivity is governed in part by the microstructure of the particle layer. The problem of these printed thermistor structures is not only the use of heavy metals, they also tend to be more apt to suffer from drift, hysteresis and poor linear behaviour (of. B value) than the conventional thermistor structures. Some printed electronics thermistors use silicon particles that have a size in the range of 10 nanometers to 100 micrometers and a surface that allows transport of electrical charge between the particles, limited by thermally activated processes. However, the availability of these silicon nanoparticle materials for industrial use has been problematic. There are also common concerns to the oxidative stability of silicon particles, so further alternatives are actively sought after.

### BRIEF DESCRIPTION

Examples of this application describe an improved negative temperature coefficient type thermistor structure that is printable and does not include toxic heavy metals.

This is achieved with a thermistor configuration, a method, and a printed electrical device characterized by what is stated in the independent claims. The preferred embodiments are disclosed in the dependent claims.

In the following examples, a negative temperature coefficient type thermistor comprises at least two conductor terminals and a thermistor structure formed of particles of lithium manganese oxide in a spinel structure within a polymer binder. The thermistor is configured to operate in a temperature range below a predefined first temperature and the polymer binder is selected so that its heat distortion temperature is higher than the first temperature. The manufacturing process further includes a stage of calendering the thermistor structure in a temperature that is higher than the heat distortion temperature of the polymer binder.

### BRIEF DESCRIPTION OF THE DRAWINGS

In the following the disclosure will be described in greater detail by means of preferred embodiments with reference to the accompanying drawings, in which

FIG. 1 shows an example that illustrates layer structures of a negative temperature coefficient type thermistor;

FIGS. 2a to 2e illustrate the effect of a temperature-controlled calendering stage for the operability of the thermistor;

FIG. 3 illustrates an alternative configuration for layer structures of the thermistor;

FIG. 4 illustrates a further alternative configuration for layer structures of the thermistor; and

FIG. 5 illustrates configuration of an electrical device that includes a negative temperature coefficient type thermistor.

### DETAILED DESCRIPTION

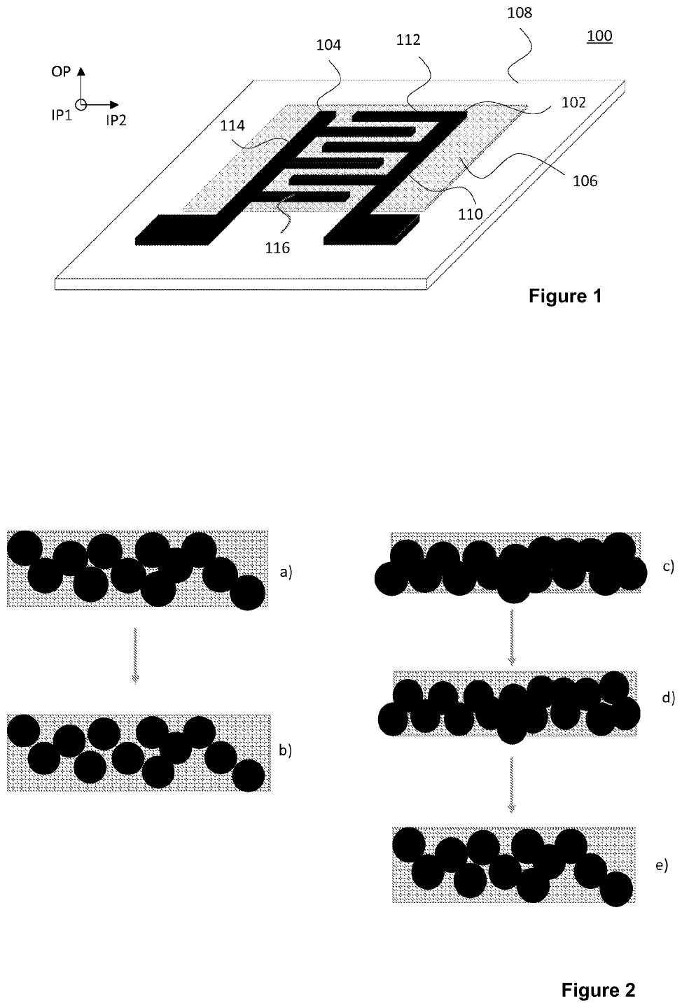

FIG. 1 shows an example that illustrates layer structures of a negative temperature coefficient type thermistor 100. The term layer in this text refers to a thickness of deposited material that fully or partially covers an underlying surface, which in turn is formed by one or more previously deposited layers. The underlying surface may be planar if, for example, it is provided by a planar carrier sheet, or it may be patterned or curved resulting from formations in previously deposited layers. In sequentially progressing deposition stages, a presently deposited layer tends to conform to the form of the underlying surface and, for example, fill patterned recesses, if such exist in the underlying layer. A layer structure anyhow extends mainly in two mutually orthogonal in-plane directions IP1 and IP2 which form a reference plane. The thickness of each layer extends in an out-of-plane direction OP, which is orthogonal to the two in-plane directions IP1, IP2, as shown in FIG. 1.

The thermistor includes at least two conductor terminals, a first terminal 102 and a second terminal 104. The conductor terminals 102, 102 establish electrical contacts to a thermistor structure 106, a volume of material whose resistance is strongly dependent on temperature. In the examples herein, the thermistor structure 106 is formed of particles of lithium manganese oxide in a spinel structure within a polymer binder.

Lithium manganese oxide in a spinel structure (LiMn2O4) has been detected to be a very advantageous particle material for printable thermistor structures because of its non-toxicity. It is also suitable for various applications because the overall conductivity of the thermistor structure can be varied by adjusting its lithium content. Lithium manganese oxide in its pristine spinel structure suffers from Jahn-Teller-distortions, but it has now been detected that in printed form, these do not have essential effect.

Electrical conduction in the thermistor structure occurs through a hopping percolation process. As described in Isihara A. (1998) Hopping, Percolation and Conductance Fluctuations. In: Electron Liquids. Springer Series in Solid-State Sciences, vol 96. Springer, Berlin, Heidelberg, pages 189-190, hopping of electrons between localized states at finite temperatures can cause conduction, and in order to sustain a finite conductivity hopping processes must be continued from one end to the other of a given system. Percolation depends on the concentration ratio of the conductive to nonconductive parts. If the probability of finding conductive parts is small, they are scattered like islands in a nonconductive ocean. As this probability increases these islands will start clustering together to form larger and larger clusters and finally macroscopic clusters connecting one end of the system to the other appear and conductive channels are opened.

The problem is, however, that changes in temperature also affect the polymer binder. In general, all substances expand or contract when their temperature changes, with expansion or contraction often occurring in all directions. Thermal expansion describes the tendency of matter to change its shape, area, volume, and density in response to a change in temperature. Furthermore, polymer materials tend to soften and harden according to changes in temperature. To control and utilize this effect, a softening point can be determined for applied materials. The softening point is the temperature at which a material softens beyond some selected softness. The heat deflection temperature or heat distortion temperature (HDT, HDTUL, or DTUL) of a polymer material is the temperature at which the polymer binder deforms under a specified load. The heat deflection temperature can be determined by a test procedure outlined in ASTM D648 and it is similar to the test procedure defined in the ISO 75 standard. In the test, the test specimen is loaded in three-point bending in the edgewise direction. The stress used for testing is either 0.455 MPa or 1.82 MPa, and the temperature is increased at 2° C./min until at the heat deflection temperature, the specimen deflects 0.25 mm. Examples of applicable polymer binders thus include polymeric or silicone-type of binders such as esters, olephinic-polymers, vinyls, -urethanes, epoxies, acrylates, cyclo-olephinic polymers and co-polymers, styrenes, sulphones, silicones, and silanes.

Accordingly, the ink composition now described has many advantages but with varying temperatures, changes in the percolation pathway tend to happen uncontrollably, and cause instability to the operation of the thermistor. For example, lithium manganese oxide particles may drift inside the expanding and/or softened polymer and randomly change the designed conductivity parameters and resistance response. To eliminate such effects, the described thermistor is configured so that the heat distortion temperature of the polymer binder is higher than the selected maximum operation temperature.

A further improvement may be provided in the manufacturing phase by calendering the thermistor structure in a temperature that is higher than the heat distortion temperature of the polymer binder. Calendering refers to a process of smoothing and compressing a material during production by passing a material web through one or more pairs of heated rolls. FIGS. 2a to 2e illustrate the effect of this temperature-controlled calendering stage for the operability of the thermistor. FIG. 2a illustrates a thermistor structure 106 of FIG. 1 comprising the lithium manganese oxide particles within the polymer binder. The conductive particles form a percolation pathway, conductivity of which is sensitive to changes in temperature. FIG. 2b illustrates the same thermistor structure in a situation where the temperature has risen above the heat distortion temperature of the polymer binder. Due to expansion and softening of the polymer material, the lithium manganese oxide particles move and a distortion takes place in the percolation path. FIG. 2c illustrates the same thermistor structure 106 that has been calendered using roll temperatures above the heat distortion temperature of the polymer binder. Due to this, the structure is compacted, and the particles have come to closer proximity to each other. When the thermistor structure cools down to temperatures below the heat distortion temperature of the polymer binder, it remains in this compacted form. The lithium manganese oxide particles within the solid elastic polymer are now more densely packed which enables higher conductivity of the thermistor.

FIG. 2d illustrates an operational situation, where the temperature of the compacted thermistor structure has risen but remains in the designed operational range and is thus not above the heat distortion temperature of the polymer binder. The schematic drawing illustrates that the temperature change causes some expansion, but particles are held together in the same compact proximity. FIG. 2e illustrates a further situation where the temperature has risen above the designed operational range and is above heat distortion temperature of the polymer binder. The schematic drawing illustrates that the change of temperature causes further expansion and even softening of the polymer binder. However, even in these situations, the dense compacted package is less affected than the non-calendered one.

Returning back to FIG. 1, it can be seen that the conductor terminals and the thermistor structure are layer structures, which means that the structure adapts well to industrial processing, specifically to processes of printed electronics. In the example of FIG. 1, the thermistor structure 106 is printed on a carrier sheet 108 and the conductor terminals 102, 104 form a patterned layer structure that are printed on the thermistor structure 106. In the manufacturing process, calendering of the thermistor structure can be implemented at a stage where the web or sheet to be processed comprises the carrier sheet and the thermistor structure, or alternatively after also the conductor terminals have been printed.

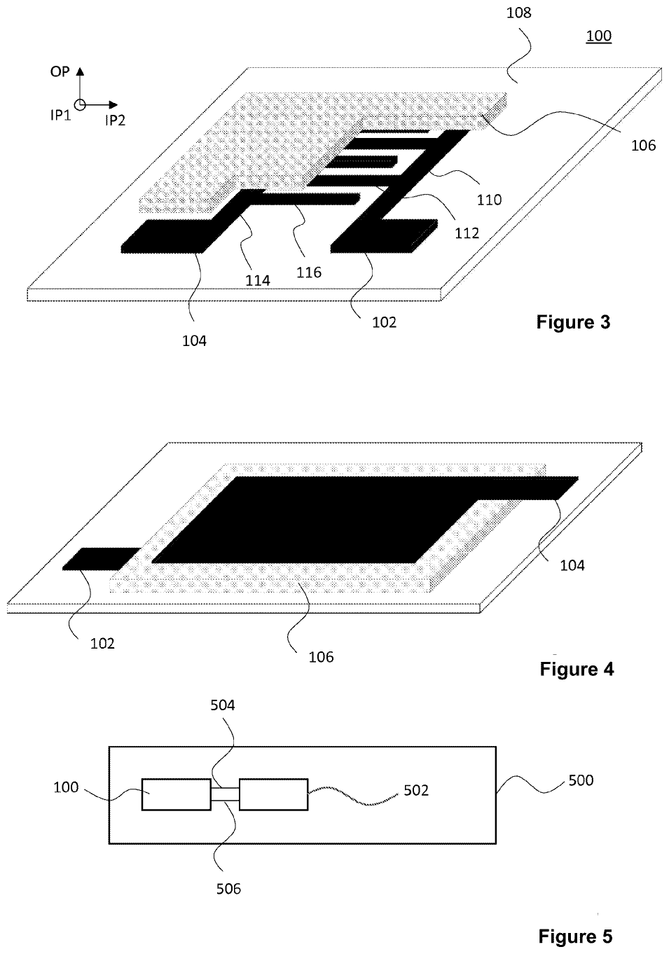

FIG. 3 illustrates an alternative configuration, where the conductor terminals 102, 104 form a patterned layer structure that is printed on a carrier sheet 108 and the thermistor structure 106 is printed on the patterned layer structure of the conductor terminals. Only part of the thermistor structure is shown in the drawing to indicate the position of the conductor terminals 102, 104, advantageously the thermistor structure covers most of the conductor terminal patterns. In the manufacturing process, the accumulated web of the carrier sheet, the conductor terminals and the thermistor structure are advantageously calendered after deposition of the thermistor structure material.

In both examples of FIG. 1 and FIG. 3, a first terminal is denoted as 102 and a second terminal is denoted as 104. The first conductor terminal 102 forms a comb pattern that includes a stem part 110 and comb fingers 112 that project from the stem part 110. Correspondingly, the second first conductor terminal 104 forms a comb pattern that includes a stem part 114 and comb fingers 116 that project from the stem part 114. In order to increase the conductive path between the conductor terminals and thus accuracy of the detected change, comb fingers 110 of the first terminal 102 are interdigitated with comb fingers 112 of the second terminal 104.

FIG. 4 illustrates an alternative configuration wherein the thermistor structure and the conductor terminals are stacked on each other. A first conductor terminal 102 is printed as a layer structure on a carrier sheet, the thermistor structure 106 is printed as a layer structure on the first conductor terminal 102. A second conductor terminal 104 is printed as a layer structure on the thermistor structure.

The block chart of FIG. 5 illustrates configuration of a printed electrical device 500 that includes the negative temperature coefficient type thermistor 100 described with examples of FIGS. 1, 3, and 4. The thermistor 100 is electrically connected to a circuit structure 502 with conductors 504, 506 that have conductor terminals 102, 104 within the thermistor 100. The circuit structure 502 is configured to detect a change in resistance of the thermistor and implement an application function in response to that. Detection and measurement of changes in thermistor resistance is well known to a person skilled in the art and will not be described in more detail herein. The printed electrical device may be configured to use detected thermistor resistance responses to, for example, measure, control or compensate temperatures, limit current in power supply circuits, or detect absence or presence of liquids. Application fields for such electrical devices include, for example, battery management, diagnostics, health and wellbeing, food delivery chains to mention some. The proposed thermistor enables implementing these functions with a configuration that is free of toxic heavy metals, and is less prone to drift, hysteresis, or instability than the conventional thermistors including them. Furthermore, the proposed thermistor configuration adapts extremely well to printed electronics processes and can thus be integrated into overall industrial manufacturing processes of the electrical device.

1. A negative temperature coefficient type thermistor configured to operate in a temperature range below a predefined first temperature, wherein the thermistor comprises at least two conductor terminals and a thermistor structure formed of particles of lithium manganese oxide in a spinel structure within a polymer binder, wherein the heat distortion temperature of the polymer binder is higher than the first temperature.

2. The thermistor according to claim 1, wherein the conductor terminals and the thermistor structure are layer structures.

3. The thermistor according to claim 2, wherein the conductor terminals form a patterned layer structure printed on a carrier sheet and the thermistor structure is printed on the patterned layer structure of the conductor terminals.

4. The thermistor according to claim 2, wherein the thermistor structure is printed on a carrier sheet and the conductor terminals form a patterned layer structure printed on the thermistor structure.

5. The thermistor according to claim 4, wherein the conductor terminals include a first terminal and a second terminal; each of the first terminal and the second terminal forms a comb pattern that includes a stem part and comb fingers that project from the stem part; the comb fingers of the first terminal are interdigitated with the comb fingers of the second terminal.

6. The thermistor according to claim 1, wherein a first conductor terminal of the conductor terminals forms a layer structure printed on a carrier sheet, the thermistor structure forms a layer structure printed on the first conductor terminal and a second conductor terminal of the conductor terminals forms a layer structure printed on the thermistor structure.

7. A method for manufacturing a negative temperature coefficient type thermistor that is configured to operate in a temperature range below a predefined first temperature, wherein the thermistor comprises at least two conductor terminals and a thermistor structure, and the method comprises: printing the thermistor structure with an ink that includes particles of lithium manganese oxide in a spinel structure and a polymer binder, wherein a heat distortion temperature of the polymer binder is higher than the first temperature; and calendaring the thermistor structure in a temperature that is higher than the heat distortion temperature of the polymer binder.

8. The method according to claim 7, comprising printing the conductor terminals and the thermistor structure as layer structures.

9. The method according to claim 8, comprising printing the conductor terminals as a patterned layer structure on a carrier sheet and printing the thermistor structure on the patterned layer structure of the conductor terminals.

10. The method according to claim 8, comprising printing the thermistor structure on a carrier sheet and printing the conductor terminals as a patterned layer structure on the thermistor structure.

11. The method according to claim 10, comprising printing the conductor terminals to include a first terminal and a second terminal, wherein the first terminal and the second terminal form a comb pattern that includes a stem part and comb fingers that project from the stem part and the comb fingers of the first terminal are interdigitated with the comb fingers of the second terminal.

12. The method according to claim 8, comprising printing a first conductor terminal of the conductor terminals as a layer structure on a carrier sheet; printing the thermistor structure as a layer structure on the first conductor terminal; and printing a second conductor terminal of the conductor terminals as a layer structure on the thermistor structure.

13. The method according to claim 9, comprising implementing the calendaring stage after printing the thermistor structure.

14. The method according to claim 9, comprising implementing the calendaring stage after printing both the thermistor structure and the conductor terminals.

15. A printed electrical device including the thermistor according to claim 1.

16. The thermistor according to claim 3, wherein the conductor terminals include a first terminal and a second terminal; wherein each of the first terminal and the second terminal forms a comb pattern that includes a stem part and comb fingers that project from the stem part; and wherein the comb fingers of the first terminal are interdigitated with the comb fingers of the second terminal.

17. The method according to claim 9, comprising printing the conductor terminals to include a first terminal and a second terminal; wherein the first terminal and the second terminal form a comb pattern that includes a stem part and comb fingers that project from the stem part and the comb fingers of the first terminal are interdigitated with the comb fingers of the second terminal.

18. The method according to claim 10, comprising implementing the calendaring stage after printing the thermistor structure.

19. The method according to claim 10, comprising implementing the calendaring stage after printing both the thermistor structure and the conductor terminals.
